(19) United States
(12) Patent Application Publication
(10) Pub. No.: US 2006/0153466 A1
(43) Pub. Date: Jul. 13, 2006

(54) System and method for video processing using overcomplete wavelet coding and circular prediction mapping

(76) Inventors: Jong Chul Ye, Clifton Park, NY (US); Mihaela Van Der Schaar, Martinez, CA (US)

Correspondence Address: PHILIPS INTELLECTUAL PROPERTY & STANDARDS, P.O. BOX 3001, BRIARCLIFF MANOR, NY, 10510, US

(21) Appl. No.: 10/562,534

(22) PCT Filed: Jun. 28, 2004
(86) PCT No.: PCT/IB04/51035

§ 371 Date: Dec. 28, 2005

Related U.S. Application Data
(60) Provisional application No. 60/483,794, filed on Jun. 30, 2003.

(51) Int. Cl. G06K 9/36

(52) U.S. Cl. 382/248; 382/232

(57) ABSTRACT

A system, method, and computer program product for fractal video coding, based on the circular prediction mapping (CPM) in overcomplete wavelet domain. According to the disclosed process, each range block [B] is approximated by a domain block [A] in circularly previous frame [Fₙ₋₁]. The size of the domain block is made larger than that of the range block using a complete-to-overcomplete transform [FIG. 2], which provides faster convergence speed compared to the conventional CPM algorithm that uses the same domain block size. However, high temporal correlation is very well exploited between the adjacent frames, since the extended reference [210] is generated by shifting the original image [202] and hence retains the high temporal correlation to the range blocks. Furthermore, the preferred embodiment provides a spatial scalability.

This application relates to a system, method, signal, and computer program product for fractal video coding. Fractal compression, which is based on the iterated function system (IFS), is known as an alternative video coding technique. The basic notion of the fractal image compression is to find a contraction mapping whose unique attractor approximates the source image. In the decoder, the mapping is applied iteratively to an arbitrary image to reconstruct the attractor. If the mapping can be represented with fewer bits than the source image, a coding gain is obtained.

More specifically, the fractal image compression techniques are based on the contraction mapping theorem and the collage theorem. The contraction mapping theorem ensures that each contraction mapping f has a unique attractor (fixed point) x_{f}, such that f(x_{f})=x_{f}

Moreover, the f can be applied iteratively to an arbitrary point y to obtain the attractor

$${x}_{f} by {lim}_{n \to ∞} {f}^{n} ( y ) = {x}_{f}$$

In the context of image coding, if the encoder finds a contraction mapping whose unique attractor is the source image, then the mapping can be successively applied to an arbitrary image to reconstruct the source image in the decoder.

As a lossy coding technique, the fractal encoder attempts to find the contraction mapping f whose collage f(x) is close to the source image x. Then the collage theorem provides the relation between the collage error at the encoder ∥x−f(x)∥ and the attractor error at the decoder ∥x−x_{f}∥ given by

$$‖ x - {x}_{f} ‖ \leq \frac{1}{1 - s} ‖ x - f ( x ) ‖$$

where s is the contractivity factor for f. This means that the decoded attractor x_{f} is close to the source image x, if the collage f(x) is close to the source image x. Therefore, the fractal coding is all about finding the contraction mapping f(x) which approximates the original image x well and has the small contractivity factor to accelerate the convergence speed.

Subsequent to the development of the first automatic algorithm for fractal coding of still images, considerable research has been performed on fractal still image coding techniques as well as video coding. One approach, called “circular prediction mapping” (CPM) is used to combine the fractal sequence coder with well-known motion estimation/motion compensation techniques. In CPM, n frames are encoded as a group, and each range block is motion compensated by a domain block in the n-circularly previous frame, which is of the same size as the range blocks. By selecting appropriate parameters in the domain-range mappings, the CPM becomes a contraction mapping. In the decoder, the CPM is applied iteratively to arbitrary n frames to reconstruct the attractor frames.

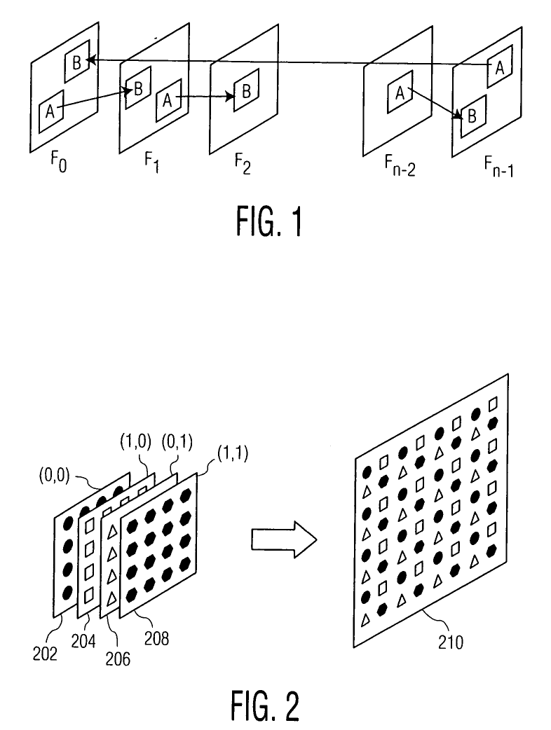

FIG. 1 depicts a CPM process wherein each range block Rᵢ (“B” blocks in FIG. 1) in the k-th frame Fₖ is approximated by a domain block Dₐ₍ᵢ₎ (“A” blocks in FIG. 1) in the n-circularly previous frame F_{[k-1]}_{ₙ}, which is of the same size as the range block. The approximation of the Rᵢ is given by
Rᵢ≅\hat{R}ᵢ=sᵢ·O(Dₐ₍ᵢ₎)+oᵢ·C
where a(i) denotes the location of the optimal domain block, and sᵢ, oᵢ are real coefficients, respectively. C is a constant block whose all pixel values are 1, and O is the orthogonalization operator. This operator removes DC component from Dₐ₍ᵢ₎, so that O(Dₐ₍ᵢ₎) and C are orthogonal to each other. After the orthogonalization, the optimal coefficients values of sᵢ, oᵢ can be directly obtained by projection of Rᵢ onto the span{O(Dₐ₍ᵢ₎)} and span{C}, respectively. Notice that the sᵢ coefficient determines the contrast scaling in the mapping, and the oᵢ coefficients represents the DC value of the range block Rᵢ.

The domain-range mapping can be interpolated as a kind of motion compensation technique. In the CPM, the motion is described only by translation, hence a(i) is the conventional motion vectors. Besides the motion estimations, the changes in contrast and overall brightness of blocks are compensated by the sᵢ, oᵢ coefficients, respectively. By setting the scaling factor sᵢ to be quantized between −1 and 1 at the encoder, the iterative application of the CPM will be eventually contractive, hence the fractal coding scheme is provided. In CPM, the domain block size is the same as the range block, so the contractivity factor is not good compared to the cases where the domain block size is larger than the range block size. The CPM process attempts to compensate for these drawbacks by an increased number of iterations at the decoder.

There is, therefore, a need in the art for a system, method, signal, and computer program product enabling faster and more efficient CPM-based fractal video coding.

The preferred embodiments include a system, method, and computer program product for fractal video coding, based on the circular prediction mapping (CPM) in overcomplete wavelet domain. According to the disclosed process, each range block is approximated by a domain block in circularly previous frame. The size of the domain block is larger than that of the range block using a complete-to-overcomplete transform, which provides faster convergence speed compared to the conventional CPM algorithm that uses the same domain block size. However, high temporal correlation is very well exploited between the adjacent frames, since the extended reference is generated by shifting the original image and hence retains the high temporal correlation to the range blocks. Furthermore, the preferred embodiment provides a spatial scalability.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the detailed description, it may be advantageous to set forth definitions of certain words and phrases used throughout this patent document:

the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document, those of ordinary skill in the art should understand that in many, if not most instances, such definitions apply to prior, as well as future uses of such defined words and phrases.

For a more complete understanding of the present invention, and the advantages thereof, reference is now made to the following descriptions taken in conjunction with the accompanying drawings, wherein like numbers designate like objects, and in which:

FIG. 1 depicts a circular predictive mapping process;

FIG. 2 depicts the generation of an extended reference frame for motion estimation from overcomplete expansion of wavelet coefficients, in accordance with an embodiment of the present invention;

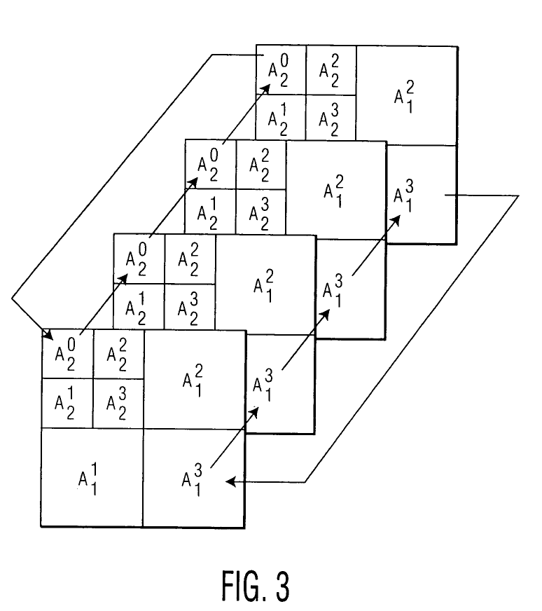

FIG. 3 depicts the structure of a circular predictive mapping process in the wavelet domain, in accordance with an embodiment of the present invention; and

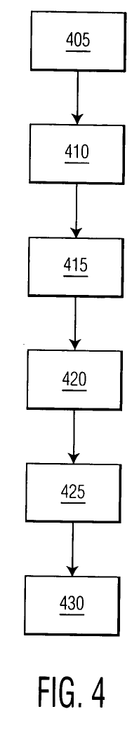

FIG. 4 depicts a flowchart of a process in accordance with an embodiment of the present invention.

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

3-D wavelet structure is an efficient video coding tool. In this wavelet framework, each of the video frames are spatially decomposed into multiple bands using wavelet filtering, and temporal correlation for each band is removed using motion estimation. Overcomplete wavelet (OW) framework overcomes that inefficiency of motion estimation in wavelet domain by considering the odd-phase wavelet coefficients in the prediction as well. A convenient way of obtaining the odd phase coefficients is the known “band shifting” method, commonly referred to as a complete-to-overcomplete transform. Since the decoded previous frame is also available at the decoder, prediction from over-complete expansion does not require any additional overhead.

The preferred embodiment uses an adaptive higher order interpolation filter for each band to maximize the motion estimation performance. The higher order filtering of the reference frame is by augmenting over-complete wavelet coefficients. For example, in order to achieve a higher order interpolation for motion estimation in HH band, three other phases of wavelet coefficients are generated from original wavelet coefficients by shifting the lower band with amount of (1,0), (0,1) and (1,1), as shown in frames 202/204/206/208 depicted in FIG. 2. Here, the original wavelet coefficients are shown as circles in the (0,0) frame 202 and in extended reference frame 210. In extended reference frame 210, the (1,0) phase-shifted coefficients are shown as squares, the (0,1) phase-shifted coefficients are shown as triangles, and (1,1) phase-shifted coefficients are shown as hexagons.

Then, four phases of wavelet coefficients are augmented and combined to generate an extended reference frame as shown in as the right frame of FIG. 2. From the extended reference, an interpolator generates a fractional pel (such as ½, ¼, ⅛, 1/16 pels) for motion estimation, as known to those of skill in the art.

Note that the generation of the extended reference in overcomplete wavelet coding algorithm is very similar to domain pool generation as known in fractal coding literature, where the domain block is usually four times larger than the range block.

According to this embodiment, n frames are encoded as a group of frames (GOF), which are first decomposed using wavelet transform as shown in FIG. 3. The original decomposition is performed as known to those of skill in the art, and as described, e.g., in United States Patent Publication US 2002/0150164, published 17 Oct. 2002, that is hereby incorporated by reference.

Then, each band is predicted blockwise from the n-circulary previous reference frames, which is four times larger after the complete-to-overcomplete transform which generates the extended reference band. More specifically, the band Aⱼⁱ(k) at the k-th frame, as shown in FIG. 3, is partitioned into range blocks, and each range block is predicted or approximated by a domain block in extended reference Aⱼⁱ([k−1]ₙ), where [k]ₙ denotes k modulo n.

In order to accelerate the convergence speed and reduce the number of iterations at the decoder, a much larger extended reference frame can be generated using ¼, ⅛, 1/16-accuracy interpolation.

Since the size of the domain block is larger than the range block in this embodiment, the convergence speed is greatly improved compared to the conventional CPM algorithm. Furthermore, the extended reference frame is generated based on the different shifts of the original images, hence there exist large temporal redundancies, so there is still more chance of good domain-range mapping even though the domain block size is bigger than the range block.

The attractor sequence can be reconstructed by iteratively applying the CPM to an arbitrary sequence. In general, the convergence speed is dependent on the ratio of the size of the domain block and the size of the range block. The larger the domain block is as compared to the range block, the faster the decoded sequence converges. Therefore, the preferred embodiment provides a much faster convergence than the conventional CPM algorithm.

The decoding iteration is repeated until the difference between the output from successive iterations becomes small. This provides inherent decoding complexity scalability, where better video quality can be obtained using more decoding iterations, but if the decoder does not have enough computational resources, the decoding iteration can be stopped to meet the computational budget.

In order enable spatial scalability, the process described in relation to FIG. 3 is modified such that the lower resolution image does not require the higher frequency band information. This is done by modifying the process to generate the extended reference frame. For example, in FIG. 3, the complete-to-overcomplete transform is not applied for A₂⁰ and the conventional CPM algorithm is used, whereas all other band are encoded using the new CPM algorithm in overcomplete wavelet domain. By modifying this, spatial scalability can be realized. In another embodiment of the algorithm, the LL band of the spatial decomposition is encoded using the conventional motion predictive DCT technique or motion compensated temporal filtering while the other higher resolution bands are encoded using the disclosed CPM process.

In various embodiments of the process described above, conventional MC-DCT coding technique is applied to subset of subbands of the wavelet decomposition (such as LLLL) to allow the backward compatibility to the conventional video coding standard such as MPEG. Also, in some embodiments, part of the subbands are used at the decoder to satisfy different sets of display size, enhancing spatial scalability. Further, in some embodiments, the iteration number is determined by the decoder to satisfy the complexity constraint of the decoder.

FIG. 4 depicts a flowchart of a process in accordance with a preferred embodiment of the present invention. According to this process, the system will first receive an image signal comprising a series of image frames (step 405). Each frame is then decomposed into multiple bands, using wavelet filtering, and spatial redundancy is removed (step 410). A complete-to-overcomplete interpolation filter is applied and the resulting phase-shifted wavelet coefficients are combined to produce an extended reference frame which is significantly larger than the original frames (step 415).

An n number of frames are then decomposed using a wavelet transform (step 420) and encoded as a group-of-frames (GOF, step 425). Then, each band is partitioning multiple range blocks and domain blocks, and these are predicted blockwise from the n-circulary previous reference frames, which is significantly larger after the complete-to-overcomplete transform which generates the extended reference frame (step 430). While this embodiment shows the extended reference frame as four times larger than the original frame, this size of the reference frame can be changed according to the decomposition performed. Thus, each band, at any specific frame, is partitioned into range blocks, and each range block is predicted from a circularly-previous extended-frame domain block.

The process is then repeated, at step 415, until the desired accuracy level is obtained.

Note that each block in FIG. 4 also corresponds to a means in a video decoding controller for performing the step described. In particular, one embodiment provides a video processing system comprising a video decoding controller, the controller operable to receive a series of image frames, decompose each frame into multiple bands; filter each image frame to produce an extended reference frame corresponding to each image frame, the extended reference frames together comprising a group of frames, the group of frames being arranged in a circularly-referential structure, and partition each band of each extended reference frame into multiple range blocks and domain blocks, each range block being predicted by a domain block of the circularly previous extended reference frame in the group of frames.

In the process above, an MC-DCT coding can also be applied to a subset of subbands, of the multiple bands, of the wavelet decomposition to allow backward compatibility to a conventional video coding standard.

Those skilled in the art will recognize that, for simplicity and clarity, the full structure and operation of all video processing systems suitable for use with the present invention is not being depicted or described herein. Instead, only so much of a video processing system as is unique to the present invention or necessary for an understanding of the present invention is depicted and described. The remainder of the construction and operation of video processing system may conform to any of the various current implementations and practices known in the art.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for processing a video signal, comprising:
receiving (405) a series of image frames (Fₙ);
decomposing (410) each frame into multiple bands;
filtering (415) each image frame to produce an extended reference frame (210) corresponding to each image frame (202,204,206,208), the extended reference frames together comprising a group of frames, the group of frames being arranged in a circularly-referential structure; and
partitioning (430) each band of each extended reference frame (210) into multiple range blocks and domain blocks Aⱼⁱ, each range block being predicted by a domain block of the circularly previous extended reference frame in the group of frames.

2. The method of claim 1, wherein the filtering is a complete-to-overcomplete interpolation filter.

3. The method of claim 1, wherein each domain block (A) is larger than the corresponding range block (B).

4. The method of claim 1, wherein each domain block (A) is at least four times larger than the corresponding range block (B).

5. The method of claim 1, wherein the process is repeated.

6. The method of claim 1, wherein each extended reference frame (210) includes phase-shifted coefficients of the corresponding image frame (204,206,208).

7. The method of claim 1, further comprising applying MC-DCT coding to a subset of subbands, of the multiple bands, of the wavelet decomposition to allow the backward compatibility to a conventional video coding standard.

8. The method of claim 1, wherein a part of sub-bands of the multiple bands are used to satisfy different sets of display sizes.

9. The method of claim 1, wherein the iteration number is determined by a decoder to satisfy the complexity constraint of the decoder.

10. A video processing system comprising a video decoding controller, the controller operable to receive (405) a series of image frames (Fₙ), decompose (410) each frame into multiple bands; filter (415) each image frame to produce an extended reference frame (210) corresponding to each image frame (202,204,206,208), the extended reference frames together comprising a group of frames, the group of frames being arranged in a circularly-referential structure, and partition (430) each band of each extended reference frame (210) into multiple range blocks and domain blocks Aⱼⁱ, each range block being predicted by a domain block of the circularly previous extended reference frame in the group of frames.

11. The video processing system of claim 10, wherein the filtering is a complete-to-overcomplete interpolation filter.

12. The video processing system of claim 10, wherein each domain block block (A) is larger than the corresponding range block (B).

13. The video processing system of claim 10, wherein each domain block block (A) is four times larger than the corresponding range block (B).

14. The video processing system of claim 10, wherein the controller performs the functions iteratively.

15. The video processing system of claim 10, wherein each extended reference frame (210) includes phase-shifted coefficients of the corresponding image frame (204,206,208).

16. The video processing system of claim 10, wherein the controller is futher operable to apply MC-DCT coding to a subset of subbands, of the multiple bands, of the wavelet decomposition to allow the backward compatibility to a conventional video coding standard.

17. The video processing system of claim 10, wherein a part of sub-bands of the multiple bands are used to satisfy different sets of display sizes.

18. The video processing system of claim 10, wherein the iteration number is determined by the controller to satisfy a complexity constraint of the controller.

19. A computer program product tangibly embodied in a computer-readable medium, comprising:
instructions for receiving (405) a series of image frames (Fₙ);
instructions for decomposing (410) each frame into multiple bands;
instructions for filtering (415) each image frame to produce an extended reference frame (210) corresponding to each image frame (202,204,206,208), the extended reference frames together comprising a group of frames, the group of frames being arranged in a circularly-referential structure; and
instructions for partitioning (430) each band of each extended reference frame (210) into multiple range blocks and domain blocks Aⱼⁱ, each range block being predicted by a domain block of the circularly previous extended reference frame in the group of frames.

20. The computer program product of claim 19, wherein the filtering is a complete-to-overcomplete interpolation filter.

21. The computer program product of claim 19, wherein each domain block (A) is larger than the corresponding range block (B).

22. The computer program product of claim 19, wherein each domain block (A) is four times larger than the corresponding range block (B).

23. The computer program product of claim 19, wherein the process is repeated.

24. The computer program product of claim 19, wherein each extended reference frame (210) includes phase-shifted coefficients of the corresponding image frame (204,206,208).

25. The computer program product of claim 19, further comprising instructions for applying MC-DCT coding to a subset of subbands, of the multiple bands, of the wavelet decomposition to allow the backward compatibility to a conventional video coding standard.

26. The computer program product of claim 19, wherein a part of sub-bands of the multiple bands are used to satisfy different sets of display sizes.

27. The computer program product of claim 19, wherein the iteration number is determined by a decoder to satisfy the complexity constraint of the decoder.
